(19) United States
(12) Patent Application Publication
(10) Pub. No.: US 2011/0279502 A1
(43) Pub. Date: Nov. 17, 2011

(54) INK JET HEAD AND DRIVING METHOD THEREOF

(75) Inventors: Yoshiaki Kaneko, Shizuoka-ken (JP); Takao Izumi, Kanagawa-ken (JP); Takaya Kitawaki, Shizuoka-ken (JP); Takashi Kado, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/102,220

(22) Filed: May 6, 2011

Related U.S. Application Data
(60) Provisional application No. 61/333,356, filed on May 11, 2010.
(60) Provisional application No. 61/333,358, filed on May 11, 2010.

(51) Int. Cl. B41J 2/07; B41J 2/125

(52) U.S. Cl. 347/11

(57) ABSTRACT

According to one embodiment, an ink jet head has a pressure room that is filled with liquid, a nozzle which ejects the liquid in the pressure room, an actuator which varies a volume of the pressure room, and a processor. The processor outputs a voltage having a waveform which sequentially includes an increasing pulse for increasing the volume of the pressure room, a first decreasing pulse for decreasing the volume of the pressure room, and a second decreasing pulse for decreasing the volume of the pressure room, to the actuator as a driving voltage.

### CROSS-REFERENCE TO RELATED APPLICATIONS

This application is based upon and claims the benefit of priority from US Provisional Application No. 61/333,356, filed on May 11, 2010, the entire contents of which are incorporated herein by reference.

This application is based upon and claims the benefit of priority from US Provisional Application No. 61/333,358, filed on May 11, 2010, the entire contents of which are incorporated herein by reference.

### FIELD

Embodiments described herein relate generally to an ink jet head used in an ink jet type printer or the like, and a driving method thereof.

### BACKGROUND

A liquid ejecting device used in an ink jet type printer or the like, a so-called ink jet head includes a pressure room which is filled with ink, a nozzle which communicates with the pressure room, and an actuator which is disposed in the pressure room. The actuator increases and decreases the volume of the pressure room. A driving voltage which sequentially includes an increasing pulse for the increase and a decreasing pulse for the decrease is supplied to the actuator.

A plurality of ink droplets is continuously ejected from the nozzle, and the plurality of ink droplets forms one pixel, thereby printing a high-grayscale image. If the frequency of the driving voltage supplied to the actuator increases, the printing speed can be heightened because an ejecting interval of the plurality of ink droplets ejected from the nozzle is shortened.

However, each time one ink droplet is ejected from the nozzle, oscillation remains in the ink in the pressure room. If the next ink droplet is ejected before the oscillation becomes calm, appropriate ejecting of the ink droplets is not easy.

### BRIEF DESCRIPTION OF THE DRAWINGS

The accompanying drawings, which are incorporated in and constitute a part of the specification, illustrate embodiments of the invention, and together with the general description given above and the detailed description of embodiments given below, serve to explain the principles of the invention.

FIG. 1 is a diagram illustrating a configuration of an exemplary embodiment.

FIG. 2 is a diagram illustrating a waveform of a driving voltage when ink is ejected according to an exemplary embodiment.

FIG. 3 is a diagram illustrating a relationship between the driving voltage and the oscillation of ink.

FIG. 4 is a diagram illustrating the oscillation of ink when the driving voltage of an exemplary embodiment is in the increasing pulse and the ground voltage.

FIG. 5 is a diagram illustrating a relationship between the increasing pulse, the time width, and the ejecting speed of ink.

FIG. 6 is a diagram illustrating an allowable range of the time width of the increasing pulse.

FIG. 7 is a diagram illustrating the oscillation of ink when the driving voltage of an exemplary embodiment is in the increasing pulse, the ground potential, the first decreasing pulse, and the ground potential.

FIG. 8 is a diagram illustrating an allowable range of the time width of the increasing pulse.

FIG. 9 is a diagram illustrating comparison of the oscillation of ink when the driving voltage in FIG. 7 is used with the oscillation of ink when the driving voltage in FIG. 5 is used.

FIG. 10 is a diagram illustrating comparison of the oscillation of ink when a waveform including the ground potential, the second decreasing pulse, and the ground potential are added to the driving voltage in FIG. 7 with the oscillation of ink when the same ground potential, second decreasing pulse, and ground potential are added to the driving voltage in FIG. 5.

FIG. 11 is a diagram illustrating a waveform of a driving voltage when ink is not ejected according to an exemplary embodiment.

FIG. 12 is a diagram illustrating a relationship between the driving voltage in FIG. 11 and the oscillation of ink.

FIG. 13 is a diagram illustrating the oscillation of ink when the driving voltage in FIG. 11 is repeated.

### DETAILED DESCRIPTION

In general, according to one embodiment, an ink jet head has a pressure room that is filled with liquid; a nozzle which ejects the liquid in the pressure room; an actuator which varies a volume of the pressure room; and a processor which outputs a voltage having a waveform which sequentially includes an increasing pulse for increasing the volume of the pressure room, a first decreasing pulse for decreasing the volume of the pressure room, and a second decreasing pulse for decreasing the volume of the pressure room, to the actuator as a driving voltage, and sets a period from the beginning of the increasing pulse to the end of the first decreasing pulse to a half value or less of a resonant cycle of the liquid and the pressure room.

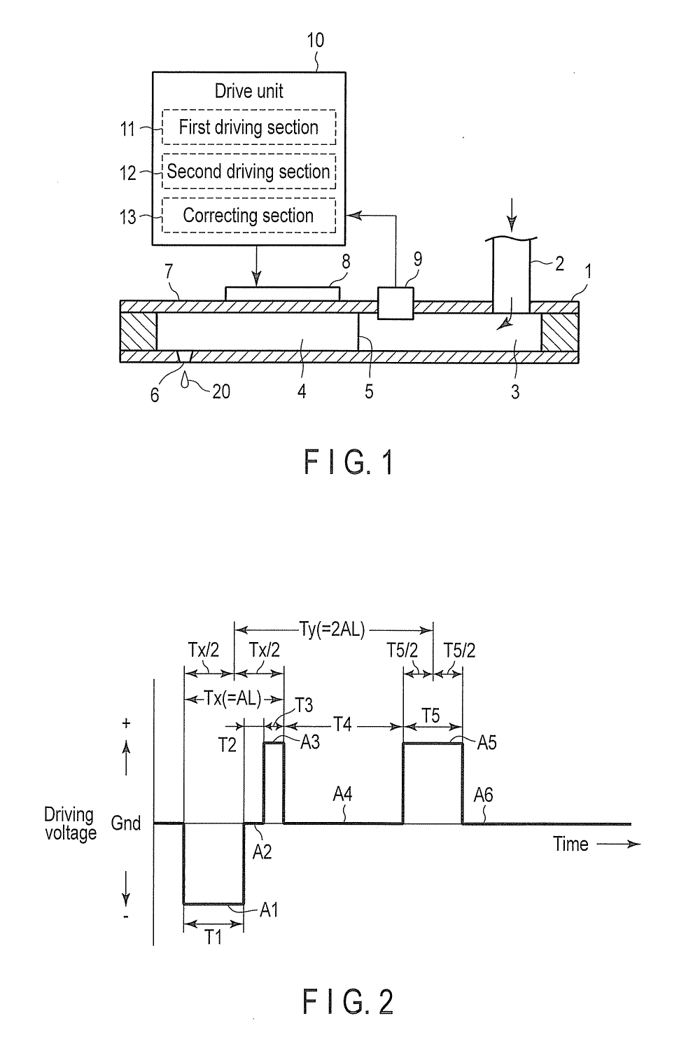

Hereinafter, an exemplary embodiment will be described with reference to the accompanying drawings. FIG. 1 shows a configuration of an ink jet head.

An ink jet head 1 includes an ink inlet 2 connected to an ink supply source, a containing room 3 which contains ink flowing thereinto from the ink inlet 2, a plurality of pressure rooms 4 which is filled with ink inside the containing room 3, a partitioning wall 5 which partitions the pressure room 4 and the containing room 3, a plurality of nozzles 6 for ejecting ink, which communicates with the pressure rooms 4, respectively, a plurality of vibrating plates 7 each of which forms one wall surface of each of the pressure rooms 4, a plurality of piezoelectric elements 8 which is disposed on the vibrating plates 7, respectively, a temperature sensor 9 which detects a temperature of ink in the containing room 3, and a driving unit (a processor) 10.

Each vibrating plate 7 and each piezoelectric element 8 form an actuator which varies the volume of each pressure room 4. If the volume of the pressure room 4 increases, ink in the containing room 3 is introduced into the pressure room 4. If the volume of the pressure room 4 decreases, the ink in the pressure room 4 is ejected from the corresponding nozzle 6 as an ink droplet 20.

The driving unit 10 outputs a driving voltage to each actuator, and has a first driving section 11, a second driving section 12, and a correction section 13. When the ink droplet 20 is ejected, the first driving section 11 outputs, to the actuator as a driving voltage as shown in FIG. 2, a voltage having a waveform which sequentially includes an increasing pulse A1 for increasing the volume of the pressure room 4, a ground potential (pulse pause) A2 for returning the volume of the pressure room 4 to a steady state from the increase due to the increasing pulse A1, a first decreasing pulse A3 for decreasing the volume of the pressure room 4, a ground potential (pulse pause) A4 for returning the volume of the pressure room 4 to the steady state from the decrease due to the first decreasing pulse A3, a second decreasing pulse A5 for decreasing the volume of the pressure room 4, and a ground potential (pulse pause) A6 for returning the volume of the pressure room 4 to the steady state from the decrease due to the second decreasing pulse A5. In addition, the first driving section repeatedly outputs the driving voltage having the waveform sequentially including A1 to A6 if a plurality of ink droplets 20 is continuously ejected.

The time width of the increasing pulse A1 is T1 (μs). The time width of the ground potential A2 is T2 (μs). The time width of the first decreasing pulse A3 is T3 (μs). The time width of the ground potential A4 is T4 (μs). The time width of the second decreasing pulse A5 is T5 (μs).

The potential of the first decreasing pulse A3 and the potential of the second decreasing pulse AS have the same polarity, and, for example, are 28V of the positive polarity. The potential of the increasing pulse A1 is 28V of the negative polarity and has the polarity opposite to the potential of the first decreasing pulse A3 and the second decreasing pulse A5. Alternatively, the potential of the first decreasing pulse A3 and the potential of the second decreasing pulse A5 may have the negative polarity, and the potential of the increasing pulse A1 may have the positive polarity.

During the period of the increasing pulse A1, the volume of the pressure room 4 increases. The increase introduces the ink in the containing room 3 into the pressure room 4. During the period of the ground potential A2, the volume of the pressure room 4 returns to the steady state from the increase due to the increasing pulse A1. During the period of the first decreasing pulse A3, the volume of the pressure room 4 decreases. The ink in the pressure room 4 is ejected from the nozzle 6 by the decrease and the return. During the period of the ground potential A4, the volume of the pressure room 4 returns to the steady state from the decrease due to the first decreasing pulse A3. In addition, during the period of the second decreasing pulse A5, the volume of the pressure room 4 decreases again. Oscillation of the ink in the pressure room 4 is suppressed by the returns and the decreases. The suppression of the oscillation of the ink is referred to as damping.

When the ink is ejected, as shown in FIG. 2, the first driving section 11 sets a first period Tx (=T1+T2+T3) from the beginning of the increasing pulse Al to the end of the first decreasing pulse A3 to a half value (=AL) or less of the resonant cycle of the ink in the pressure room 4 and the pressure room 4. In addition, the first driving section 11 sets a second period Ty from the intermediate point of the first period Tx to the intermediate point of the second decreasing pulse AS to the resonant cycle or less. The resonant cycle is defined by a structure of the pressure room 4, characteristics of the ink, and the like, which is called the Helmholtz resonant cycle.

Tx≦AL, Ty=(Tx/2)+T4+(T5/2), and Ty2AL

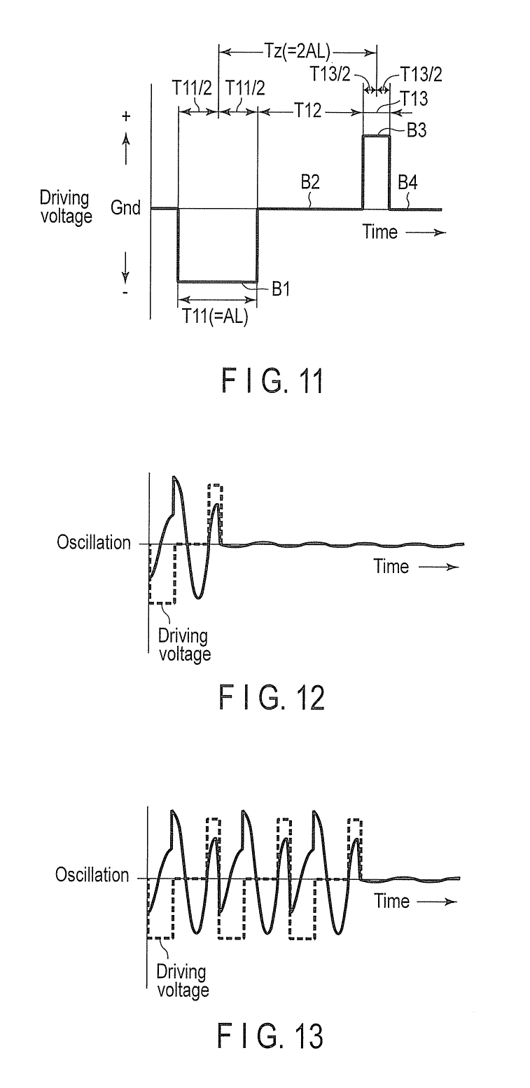

When the ink is not ejected, as shown in FIG. 11, the second driving section 12 outputs, to the actuator as the driving voltage, a voltage having a waveform which sequentially includes an increasing pulse B1 for increasing the volume of the pressure room 4 to an extent that the ink in the pressure room 4 is not ejected from the nozzle 6, a ground potential (pulse pause) B2 for returning the volume of the pressure room 4 to the steady state from the increase due to the increasing pulse B1, a decreasing pulse B3 for decreasing the volume of the pressure room 4 to an extent that the ink is not ejected from the nozzle 6, and a ground potential (pulse pause) B4 for returning the volume of the pressure room 4 to the steady state from the decrease due to the decreasing pulse B3.

The time width of the increasing pulse B1 is T11 (μs). The time width of the ground potential B2 is T12 (μs). The time width of the decreasing pulse B3 is T13 (μs).

When the ink is not ejected, as shown in FIG. 11, the second driving section 12 sets a third period Tz from the intermediate point of the increasing pulse B1 to the intermediate point of the decreasing pulse B3 to the Helmholtz resonant cycle (=2AL) or less.

The potential of the increasing pulse B1 is, for example, 16V of the negative polarity, and is lower than the potential (=28V) of the increasing pulse A1 for ejecting ink. Due to the low voltage, the ink minutely vibrates enough not to eject the ink in the pressure room 4 and meniscus at the nozzle 6. The potential of the decreasing pulse B3 is, for example, 16V of the positive polarity, which has the polarity opposite to the potential of the increasing pulse B1 and is lower than the potentials of the first and second decreasing pulses A3 and A5 (=28V) for ejecting ink. Due to the low voltage, the ink minutely vibrates enough not to eject the ink in the pressure room 4 and meniscus at the nozzle 6. Alternatively, the potential of the increasing pulse B1 may have the positive polarity, and the potential of the decreasing pulse B3 may have the negative polarity.

The correcting section 13 corrects the set first period Tx, second period Ty, and third period Ty according to a temperature detected by the temperature sensor 9.

Next, an operation of the ink jet head 1 will be described.

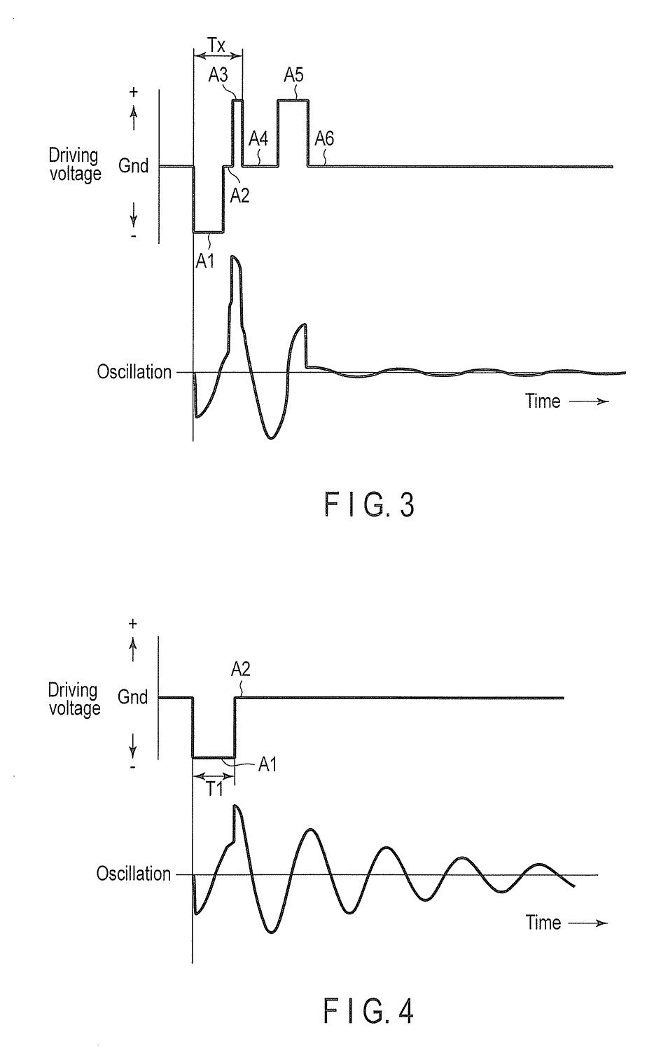

When the ink is ejected, the driving unit 10 outputs the driving voltage of the waveform sequentially including the increasing pulse A1, the ground potential A2, the first decreasing pulse A3, the ground potential A4, the second decreasing pulse A5, and the ground potential A6. At this time, the oscillation shown in FIG. 3 occurs in the ink in the pressure room 4. In other words, the ink in the pressure room 4 vibrates in one direction at the timing of the increasing pulse A1, and vibrates in the other direction at the timing of the subsequent ground potential A2 and the first decreasing pulse A3. Thereafter, the ink respectively vibrates in one and the other directions at the timing of the ground potential A4 and the second decreasing pulse A5, and then converges.

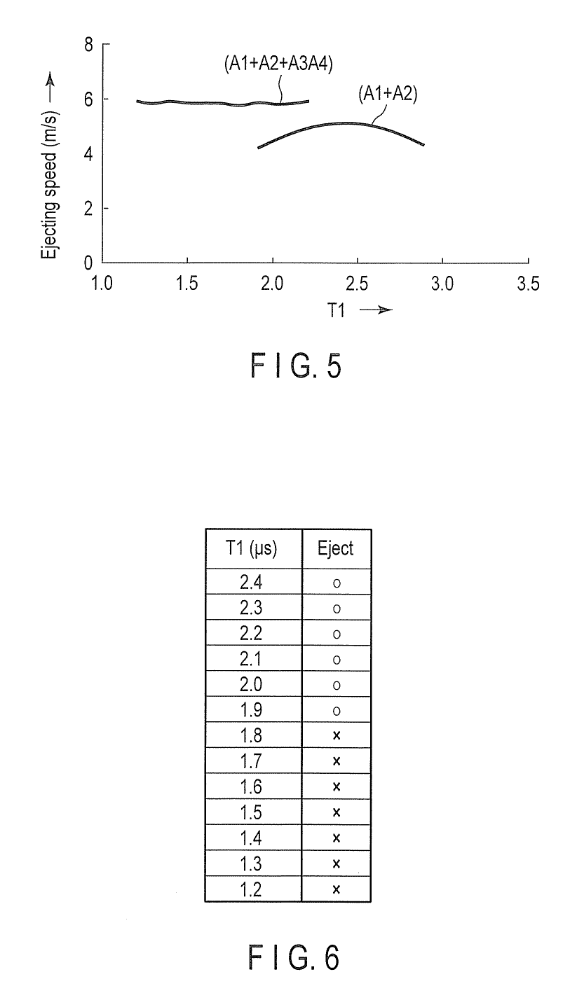

FIG. 4 shows a result which is ascertained by the test regarding how the ink in the pressure room 4 vibrates if the Helmholtz resonant cycle is, for example, 4.8 (μs) and the driving voltage output from the driving unit 10 has a waveform only including the increasing pulse A1 and the ground potential A2. In FIG. 5, (A1+A2) indicates a result which is ascertained by the test regarding a relationship between the time width T1 of the increasing pulse A1 and the ejecting speed of ink when the driving voltage in FIG. 4 is used. In other words, the ink in the pressure room 4 vibrates in one direction at the timing of the increasing pulse A1, vibrates in the other direction at the timing of the ground potential A2 and the first decreasing pulse A3, and remains as it is without converging.

The ejecting speed of ink reaches the peak if the time width T1 of the increasing pulse A1 is close to 2.4 (μs) which is a half of the Helmholtz resonant cycle. If the time width Ti of the increasing pulse A1 is equal to or less than 1.8 (μs), there is no ejecting ink. An allowable range of the time width Ti of the increasing pulse A1, which enables the ink to be ejected, is 2.4 (μs) to 1.9 (μs), as shown in FIG. 6.

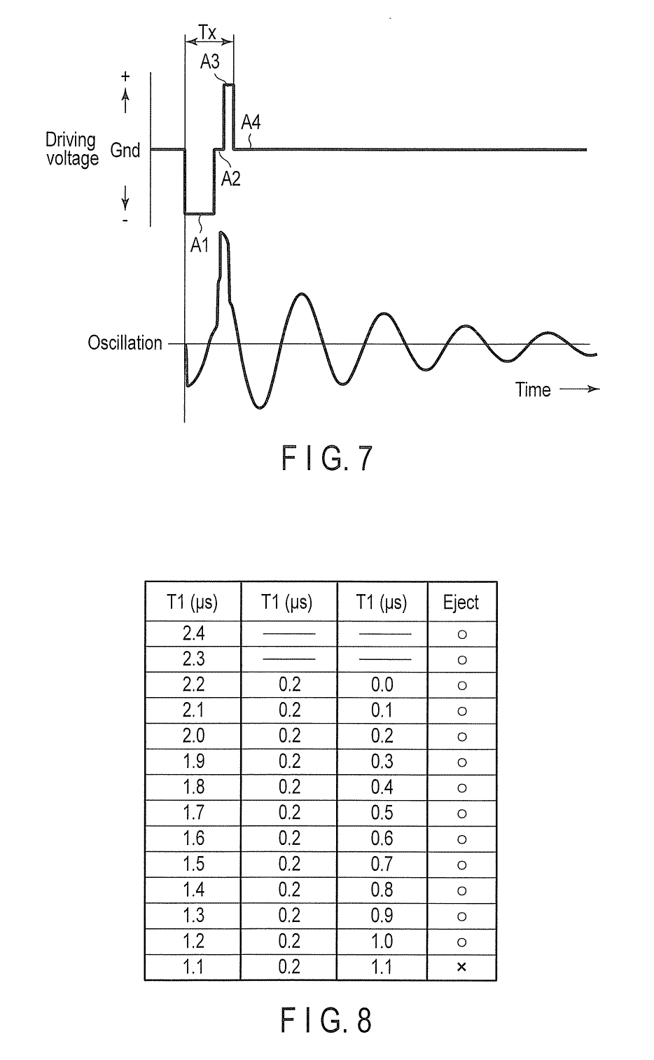

FIG. 7 shows a result which is ascertained by the test regarding how the ink in the pressure room 4 vibrates if a half value of the Helmholtz resonant cycle is, for example, 2.4 (μs), and the driving voltage output from the driving unit 10 has a waveform including the increasing pulse A1, the ground potential A2, the first decreasing pulse A3, and the ground potential A4. Here, the first period Tx (=T1+T2+T3) from the beginning of the increasing pulse Al to the end of the first decreasing pulse A3 is equal to or less than the half value of the Helmholtz resonant cycle, and the time width T2 of the ground potential A2 is 0.2 (μs). In FIG. 5, (A1+A2+A3+A4) indicates a result which is ascertained by the test regarding a relationship between the time width T1 of the increasing pulse A1 and the ejecting speed of ink if the driving voltage in FIG. 7 is used. In other words, the ink in the pressure room 4 vibrates in one direction at the timing of the increasing pulse A1, greatly vibrates in the other direction at the timing of the subsequent ground potential A2 and first decreasing pulse A3, and remains as it is without converging.

The ejecting speed of ink is nearly constant in a range where the time width T1 of the increasing pulse A1 is 2.2 (μs) to 1.2 (μs). If the time width T1 of the increasing pulse A1 is equal to or less than 1.1 (μs), there is no ejecting ink. An allowable range of the time width T1 of the increasing pulse A1, which enables the ink to be ejected, is 2.4 (μs) to 1.2 (μs), as shown in FIG. 8. In other words, the time width T1 of the increasing pulse A1 can be further reduced by adding the ground potential A2, the first decreasing pulse A3, and the ground potential A4 to the increasing pulse A1.

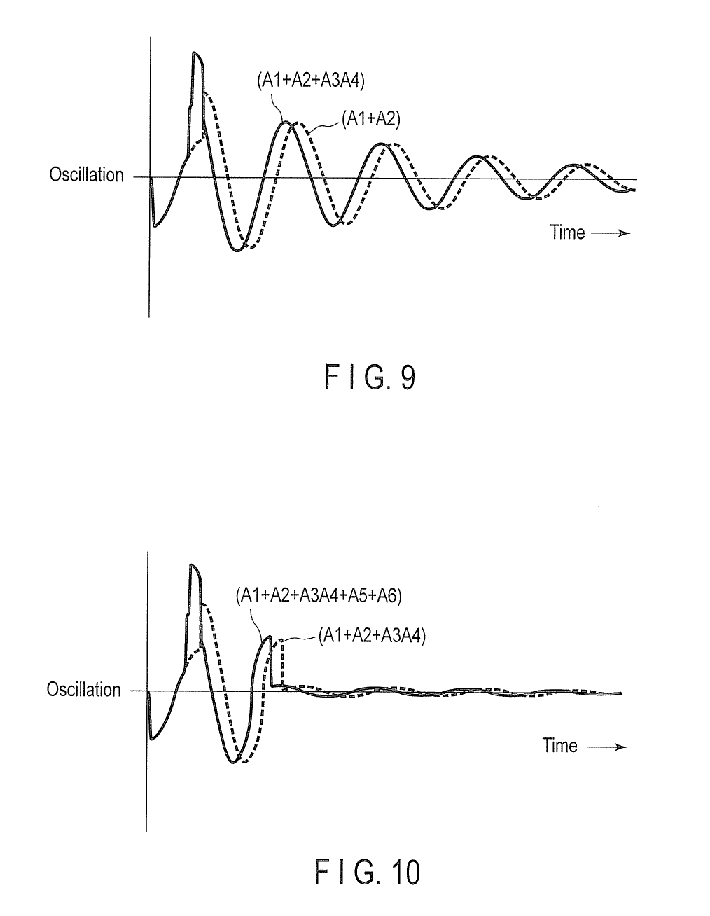

FIG. 9 shows a comparison of the oscillation of the ink when the driving voltage in FIG. 7 is used with the oscillation of the ink when the driving voltage in FIG. 5 is used. In other words, the phase of the oscillation of the ink when the driving voltage in FIG. 7 is used precedes the phase of the oscillation of the ink when the driving voltage in FIG. 5 is used. The shorter the time width T1 of the increasing pulse A1 is, the larger the preceding width of the phase is.

In summary, if the driving voltage supplied to the actuator has the waveform in FIG. 7 including the increasing pulse A1, the ground potential A2, the first decreasing pulse A3, and the ground potential A4, and the first period Tx (=T1+T2+T3) from the beginning of the increasing pulse A1 to the end of the first decreasing pulse A3 is equal to or less than the half value of the Helmholtz resonant cycle, the phase of the oscillation of the ink can precede. Even though the driving voltage supplied to the actuator has the waveform in FIG. 7 including the increasing pulse A1, the ground potential A2, the first decreasing pulse A3, and the ground potential A4, if the first period Tx (=T1+T2+T3) from the beginning of the increasing pulse A1 to the end of the first decreasing pulse A3 is larger than the half value of the Helmholtz resonant cycle, the phase of the oscillation of the ink is the same as or lags behind the phase in the case of the driving voltage in FIG. 5.

FIG. 10 shows a comparison of the oscillation of the ink when a waveform including the ground potential A4, the second decreasing pulse A5, and the ground potential A6 is added to the driving voltage having the waveform in FIG. 7, with the oscillation of the ink when the waveform including the same ground potential A4, second decreasing pulse A5, and ground potential A6 is added to the driving voltage having the waveform in FIG. 5. The waveform including the ground potential A4, the second decreasing pulse A5, and the ground potential A6 is used for so-called damping, that is, for suppressing the oscillation of the ink.

As described above, when the driving voltage having the waveform in FIG. 7 is used, the phase of the oscillation of the ink precedes the phase when the driving voltage having the waveform in FIG. 5 is used, and thereby the damping operation can be added at an earlier point of time corresponding to the preceding amount of the phase. In other words, the oscillation of the ink when the waveform including the ground potential A4, the second decreasing pulse A5, and the ground potential A6 is added to the driving voltage having the waveform in FIG. 7 converges earlier than the oscillation of the ink when the waveform including the same ground potential A4, second decreasing pulse A5, and ground potential A6 is added to the driving voltage having the waveform in FIG. 5.

A driving voltage obtained by adding the waveform including the ground potential A4, the second decreasing pulse A5, and the ground potential A6 to the driving voltage having the waveform in FIG. 7 corresponds to the driving voltage having the waveform in FIG. 2.

The second decreasing pulse A5 is required to be set to the optimal timing so as to efficiently cancel the oscillation of the ink generated by the increasing pulse A1 and the first decreasing pulse A3. This optimal timing depends on the Helmholtz resonant cycle which is defined by a structure of the pressure room 4 and the characteristics of the ink. Taking this point into consideration, as shown in FIG. 2, the second period Ty from the intermediate point of the first period Tx (=T1+T2+T3) to the intermediate point of the second decreasing pulse AS is set to the Helmholtz resonant cycle or less.

By supplying the driving voltage having the waveform in FIG. 2 to the actuator, the oscillation occurring in the ink in the pressure room 4 due to the ejecting of one ink droplet 20 can reliably converge before ejecting a subsequent ink droplet 20. Therefore, the ejecting speed of the ink can increase without having an ill effect on the ejecting of the ink.

In addition, if the temperature of the ink varies due to influence of an ambient temperature, the Helmholtz resonant cycle fluctuates accordingly. The driving unit 10 corrects the first period Tx and the second period Ty according to a temperature detected by the temperature sensor 9 so as not to be influenced by the variation in the Helmholtz resonant cycle.

On the other hand, when the ink is not ejected, as shown in FIG. 11, the driving unit 10 outputs a driving voltage having a waveform which sequentially includes an increasing pulse B1 for increasing the volume of the pressure room 4 to an extent that the ink in the pressure room 4 is not ejected from the nozzle 6, a ground potential (pulse pause) B2 for returning the volume of the pressure room 4 to the steady state from the increase due to the increasing pulse B1, a decreasing pulse B3 for decreasing the volume of the pressure room 4 to an extent that the ink in the pressure room 4 is not ejected from the nozzle 6, and a ground potential (pulse pause) B4 for returning the volume of the pressure room 4 to the steady state from the decrease due to the decreasing pulse B3.

Due to the supply of the driving voltage to the actuator, the ink minutely vibrates enough not to eject the ink in the pressure room 4 and meniscus at the nozzle 6, as shown in FIG. 12. The minute oscillation stirs the ink in the pressure room 4. The stirring does not increase the viscosity of the ink more than necessary. Since the viscosity of the ink does not increase more than necessary, an ejecting efficiency is improved when the ink is ejected.

The time width T11 of the increasing pulse B1 is preferably close to the half value of the Helmholtz resonant cycle and does not necessarily correspond with the half value of the Helmholtz resonant cycle. The decreasing pulse B3 is required to be set to the optimal timing so as to efficiently cancel the minute oscillation of the ink generated by the increasing pulse B1. The optimal timing depends on the Helmholtz resonant cycle which is defined by a structure of the pressure room 4 and the characteristics of the ink. Taking this point into consideration, as shown in FIG. 11, the third period Tz from the intermediate point of the increasing pulse B1 to the intermediate point of the decreasing pulse B3 is set to the Helmholtz resonant cycle (=2AL) or less.

Tz=(T11/2)+T12+(T13/2), and Tz≦2AL

If the half value of the Helmholtz resonant cycle is, for example, 2.4 (μs), the time width T11 of the increasing pulse B1 is set to 2.3 (μs), and the time width T13 of the decreasing pulse B3 is set to 1.0 (μs), the time width T12 of the ground potential B2 becomes 3.15 (μs).

The minute oscillation generated by the increasing pulse B1 can reliably converge due to the decreasing pulse B3 before subsequent ejecting of the ink starts. Therefore, an ill effect on the ejecting of the ink does not occur.

In addition, the driving voltage having the waveform in FIG. 11 may be supplied to the actuator three times repeatedly. FIG. 13 shows a relationship between the driving voltage and the minute oscillation in this case.

In addition, if the temperature of the ink varies due to the influence of an ambient temperature, the Helmholtz resonant cycle fluctuates accordingly. The driving unit 10 corrects the third period Tz according to a temperature detected by the temperature sensor 9 so as not to be influenced by the variation in the Helmholtz resonant cycle.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink jet head comprising:
a pressure room which is filled with liquid;
a nozzle which ejects the liquid in the pressure room;
an actuator which varies a volume of the pressure room; and
a processor which outputs a voltage having a waveform which sequentially includes an increasing pulse for increasing the volume of the pressure room, a first decreasing pulse for decreasing the volume of the pressure room, and a second decreasing pulse for decreasing the volume of the pressure room, to the actuator as a driving voltage, and sets a period from the beginning of the increasing pulse to the end of the first decreasing pulse to a half value or less of a resonant cycle of the liquid and the pressure room.

2. The head of claim 1, wherein
the processor outputs a voltage having a waveform which sequentially includes the increasing pulse, a ground potential for returning the volume of the pressure room to a steady state from the increase due to the increasing pulse, the first decreasing pulse, a ground potential for returning the volume of the pressure room to the steady state from the decrease due to the first decreasing pulse, the second decreasing pulse, and a ground potential for returning the volume of the pressure room to the steady state from the decrease due to the second decreasing pulse, to the actuator as the driving voltage.

3. The head of claim 1, wherein the processor repeatedly outputs the driving voltage if the liquid is continuously ejected.

4. The head of claim 1, wherein
the processor sets a first period from the beginning of the increasing pulse to the end of the first decreasing pulse to the half value or less of the resonant cycle of the liquid and the pressure room, and sets a second period from an intermediate point of the first period to an intermediate point of the second decreasing pulse to the resonant cycle or less.

5. The head of claim 4, further comprising:
a temperature sensor that detects a temperature of the liquid in the pressure room.

6. The head of claim 5, wherein
the processor corrects the set first and second periods according to a temperature detected by the temperature sensor.

7. The head of claim 1, wherein
a potential of the first decreasing pulse and a potential of the second decreasing pulse have the same polarity, and
a potential of the increasing pulse has a polarity opposite to the potentials of the first decreasing pulse and the second decreasing pulse.

8. A method for driving an ink jet head having a pressure room which is filled with liquid, a nozzle which ejects the liquid in the pressure room, and an actuator which varies a volume of the pressure room, comprising:
outputting a voltage having a waveform which sequentially includes an increasing pulse for increasing the volume of the pressure room, a first decreasing pulse for decreasing the volume of the pressure room, and a second decreasing pulse for decreasing the volume of the pressure room, to the actuator as a driving voltage; and
setting a period from the beginning of the increasing pulse to the end of the first decreasing pulse to a half value or less of a resonant cycle of the liquid and the pressure room.

9. The method of claim 8, wherein the outputting of the voltage includes outputting a voltage having a waveform which sequentially includes the increasing pulse, a ground potential for returning the volume of the pressure room to a steady state from the increase due to the increasing pulse, the first decreasing pulse, a ground potential for returning the volume of the pressure room to the steady state from the decrease due to the first decreasing pulse, the second decreasing pulse, and a ground potential for returning the volume of the pressure room to the steady state from the decrease due to the second decreasing pulse, to the actuator as a driving voltage.

10. The method of claim 8, wherein
the setting of the period includes setting a first period from the beginning of the increasing pulse to the end of the first decreasing pulse to the half value or less of the resonant cycle of the liquid and the pressure room, and setting a second period from an intermediate point of the first period to an intermediate point of the second decreasing pulse to the resonant cycle or less.

11. The method of claim 8, wherein
a potential of the first decreasing pulse and a potential of the second decreasing pulse have the same polarity, and
wherein a potential of the increasing pulse has a polarity opposite to the potentials of the first decreasing pulse and the second decreasing pulse.

12. An ink jet head comprising:
a pressure room which is filled with liquid;
a nozzle which ejects the liquid in the pressure room;
an actuator which varies a volume of the pressure room; and
a processor which outputs a voltage for varying the volume of the pressure room so as to eject the liquid in the pressure room from the nozzle, to the actuator as a driving voltage, if the liquid is ejected, outputs a voltage having a waveform which sequentially includes an increasing pulse and a decreasing pulse for increasing and decreasing the volume of the pressure room to an extent that the liquid in the pressure room is not ejected, to the actuator as a driving voltage, if the liquid is not ejected, and sets a period from an intermediate point of the increasing pulse to an intermediate point of the decreasing pulse to a resonant cycle or less of the liquid and the pressure room.

13. The head of claim 12, wherein
the driving voltage supplied to the actuator if the liquid is not ejected is lower than the driving voltage supplied to the actuator if the liquid is ejected.

14. The head of claim 12, wherein
the processor outputs a voltage having a waveform which sequentially includes the increasing pulse, a ground potential for returning the volume of the pressure room to a steady state from the increase due to the increasing pulse, the decreasing pulse, and a ground potential for returning the volume of the pressure room to the steady state from the decrease due to the decreasing pulse, to the actuator as the driving voltage, if the liquid is not ejected.

15. The head of claim 12, further comprising:
a temperature sensor that detects a temperature of the liquid in the pressure room.

16. The head of claim 15, wherein
the processor corrects the set period according to a temperature detected by the temperature sensor.

17. The head of claim 12, wherein
a potential of the increasing pulse and a potential of the decreasing pulse have polarities opposite to each other.
